(19) United States
(12) Patent Application Publication
(10) Pub. No.: US 2022/0056677 A1
(43) Pub. Date: Feb. 24, 2022

(54) Quick Access Plumbing Fixture

(71) Applicant: Arthur Roland Kam, Honoluli, HI (US)

(72) Inventor: Arthur Roland Kam, Honoluli, HI (US)

(21) Appl. No.: 17/402,780

(22) Filed: Aug. 16, 2021

Related U.S. Application Data
(60) Provisional application No. 63/067,413, filed on Aug. 19, 2020.

(51) Int. Cl. E03C 1/02; E03C 1/042; E03C 1/04

(52) U.S. Cl. CPC E03C 1/023; E03C 1/0408; E03C 1/042

(57) ABSTRACT

The plumbing fixture of the present invention allows a user to quickly and easily attach an accessory, such as a water hose, to a water source in order to transport water to a location that is without water. More specifically, the plumbing fixture provides quick and easy access to a water supply for purposes of, for example, extinguishing a fire. The plumbing fixture also provides a means for a user to perform various activities whereby access to water would be beneficial, such as cleaning floors, bathing pets, people, or watering plants.

### CROSS-REFERENCE TO RELATED APPLICATION

The present application claims priority to, and the benefit of, U.S. Provisional Application No. 63/067,413, which was filed on Aug. 19, 2020, and is incorporated herein by reference in its entirety.

### FIELD OF THE INVENTION

The present invention relates generally to the field of plumbing accessories. More specifically, the present invention relates to a generally T-shaped attachment for a water supply equipped with, among other things, a connection device suitable for connecting a garden or household water hose. The plumbing accessory of the present invention allows a user to quickly and easily access a water supply in order to, for example, extinguish a fire that may have started in or near the household. The t-shaped attachment device of the present invention also allows a user to water plants, clean floors, or engage in any other activity where having a convenient water source at hand is more advantageous than repeatedly filling and emptying a bucket. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, many times an individual has a need for water at a location where no convenient water source exists. For example, a fire igniting in or around a home is one such instance where access to a water source is vital in order to limit the spread of the fire and preserve both life and property. Without quick access to a water source, pets, plants, and belongings may be severely damaged, and individuals may sustain serious bodily injury or even death if a fire is not extinguished quickly. Further, entire buildings and structures may be destroyed by a fire without immediate action to extinguish the fire. Accordingly, in order for an individual to contain or extinguish a fire and thereby protect themself from serious bodily injury and protect other items from severe damage, an individual would need to call a fire emergency response team and evacuate the area until said team has arrived. Furthermore, an individual would likely not have enough time to remove their belongings from the area, as fire emergency response teams may not always be quick enough to the scene to avoid irreparable damage or death.

Another limitation present when there is a lack of water on hand is the inconvenience of filling a bucket or other container for use in a location without water or where water cannot be easily supplied. More often than not, an individual will need to constantly go back and forth from the water source to refill a bucket or container until the activity is completed. Accordingly, refilling buckets can take valuable time, which in the event of a fire emergency could allow the fire to grow and fire damage to increase. Furthermore, an individual may also be sitting or stooped position as the refill containers with water. As a result, this continuous refilling a container may cause undue stress on an individual as they bend over, stand up, and sit down each time they must refill the container until the activity is completed. In addition, a full water bucket can be incredibly heavy and difficult to transport, thereby leading to back strain and/or spillage of the water when moving the bucket from place to place. As a result, this additional stress may cause other health ramifications depending on the type of activity the user is performing.

Therefore, there exists a long-felt need in the art for a plumbing device or accessory that can be used for quick and convenient access to a water source. More specifically, there is a long-felt need in the art for an attachment that can be quickly and easily installed to any existing water pipe in a home or building. Moreover, there is a long-felt need in the art for a plumbing attachment device that is comprised of a connection point for a watering hose in order to transport water to a location away from the water pipe and to the area where water is needed. Finally, there is a long-felt need in the art for a plumbing attachment device that is relatively inexpensive to manufacture, is both safe and easy to use, and that is effective in extinguishing fires and assisting users with other types of activities where water is needed at a location not near a water source.

The subject matter disclosed and claimed herein, in one embodiment thereof, is comprised of a plumbing diverter attachment that is generally T-shaped attachment, a connector and a cap. The T-shaped attachment has three generally cylindrical legs, each having an opening therein that may be placed in fluid communication with the openings of the other two cylindrical legs. Further, two of said legs are in parallel with one another and share a common longitudinal axis. The third leg is at an approximately perpendicular to said longitudinal axis. A first end of the connector is also removably attachable to the third leg of the fixture/diverter to allow the third leg to be in fluid communication therewith, and said third leg of the connector can be easily attached to a garden or other watering hose when needed. When a watering hose is not attached or needed, the cap is inserted into or screwed onto the open end of the connector to prevent water from passing through, thereby allowing the existing water line to function as intended (i.e., wherein the water is not being diverted through the connector). Accordingly, the attachment is relatively small, easy to handle, and may be attached to an existing domestic water source such as a water line, shower head, faucet, spigot, etc. in a relatively quick, convenient, and easy fashion.

In this manner, the plumbing diverter attachment device of the present invention accomplishes all of the forgoing objectives, and provides a user with a relatively safe, easy, convenient and cost-effective way of quickly tapping into an existing water supply. Therefore, a user can then attach a hose to the attachment in order to supply water to a secondary area. In one instance, this ability to supply water to a secondary area and be used to put out a fire, thereby saving lives and keeping people, pets, plants, belongings and other personal property safe from destruction.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The present invention relates to a novel plumbing diverter attachment that can be attached to a water source such as a water line, shower head, faucet, etc. The attachment accordingly diverts water from said water source, through a connector, and ultimately to an attached hose that can be used to put out a fire and/or complete other tasks where water is needed but not otherwise readily available. The attachment is generally comprised of three legs having a continuous opening therein that form a generally t-shaped configuration. Each of the three legs is preferably cylindrical and is hollow shape. Further, one leg can be attached to an existing water pipe and provide a seal to prevent water from leaking at the connection points. In addition, the second leg can be attached to whatever device was originally attached to the water pipe (e.g. a showerhead) to allow the device to retain function while the attachment is attached to the pipe. The connector of the attachment also allows for a water hose to be connected to the attachment and also a cap that prevents the flow of water from the third leg when the diversion of water through the third leg (and to the hose) is not needed. The cap is generally round in shape to match the connector, and effectively plugs the open end of the connector, thereby prohibiting water from flowing out of the connector via the continuous opening in the connector. However, the cap may be of any suitable shape or size, provided that it is able to effectively plug the open end of the connector.

Accordingly, the device of the present invention is particularly advantageous as it enables a user to extend a water source to a secondary area in a convenient and safe manner to allow the user to extinguish fires that may ignite and threaten people, pets, plants, or the like. In addition, the attachment of the present invention enables a user to water plants, clean floors, bathe pets or people, or perform other such activities in a secondary area that requires a supply of water but does not contain said water supply. In addition, the attachment saves the user from having to continually fill and empty a bucket and/or walking back and forth to a faucet or other water source to fill said bucket.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the plumbing diverter attachment of the present invention in accordance with the disclosed architecture, wherein the device is installed in line with a shower head supply line (shown as prior art) and further wherein the third leg is capped with a cap in accordance with the disclosed architecture;

FIG. 2A illustrates a perspective view of a user attaching a water hose to one potential embodiment of the plumbing diverter attachment of the present invention in accordance with the disclosed architecture;

FIG. 2B illustrates a perspective view of a cooking grill (shown as prior art) on fire on a patio;

FIG. 2C illustrates a perspective view of the user extinguishing the cooking grill fire of FIG. 2B with the water hose that is attached to one potential embodiment of the plumbing diverter attachment of the present invention in accordance with the disclosed architecture;

FIG. 3 illustrates a side perspective view of one potential embodiment of the plumbing diverter attachment of the present invention in accordance with the disclosed architecture, wherein the device further comprises an additional support element for holding a water hose when not in use in accordance with the disclosed architecture;

FIG. 4A illustrates a perspective view of an alternative embodiment of the plumbing accessory device of the present invention in accordance with the disclosed architecture, wherein the device is installed in line with a water supply line and further comprises a water regulator valve; and

FIG. 4B illustrates a perspective view of an alternative embodiment of the plumbing accessory device of the present invention in accordance with the disclosed architecture, wherein the device is installed in line with a water supply line and further comprises a water meter.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a plumbing diverter attachment that provides individuals with quick, convenient, and easy access to a water source during a fire. In addition, there is a long-felt need in the art for a plumbing diverter attachment that would provide easy access to a water source in a secondary area where water is not readily accessible, thereby protecting users, pets, plants, personal belongings and the like, from dangers such as fires. Moreover, there is a long-felt need in the art for a plumbing diverter attachment that would also provide individuals with access to a water source for performing other less threatening tasks such as, but not limited to, cleaning floors, bathing pets or people, watering plants and the like without the excess strain of having to continuously fill, transport, and empty a portable water container. In addition, there is a long-felt need in the art for a plumbing diverter attachment that can be quickly and easily connected and disconnected to any type of water source.

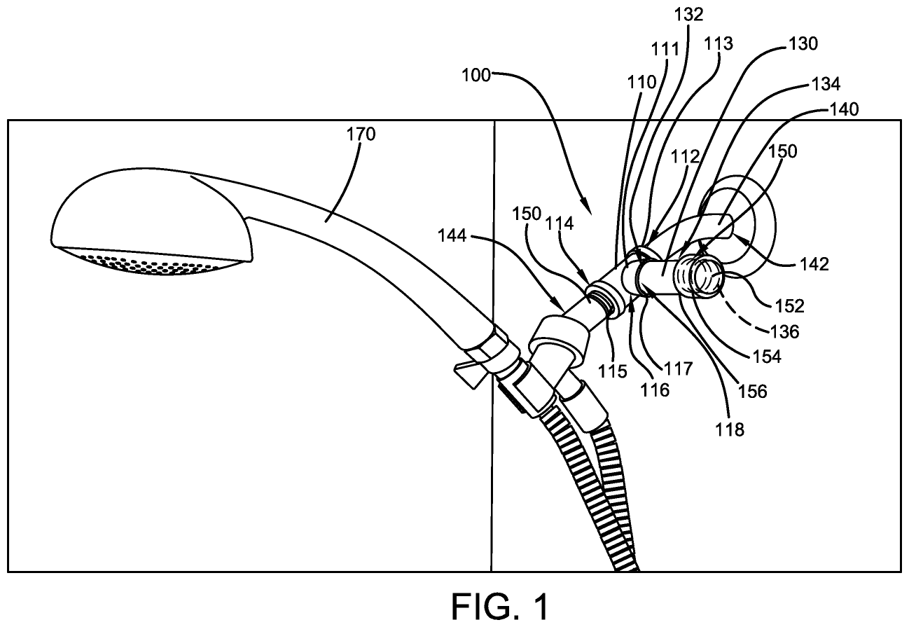

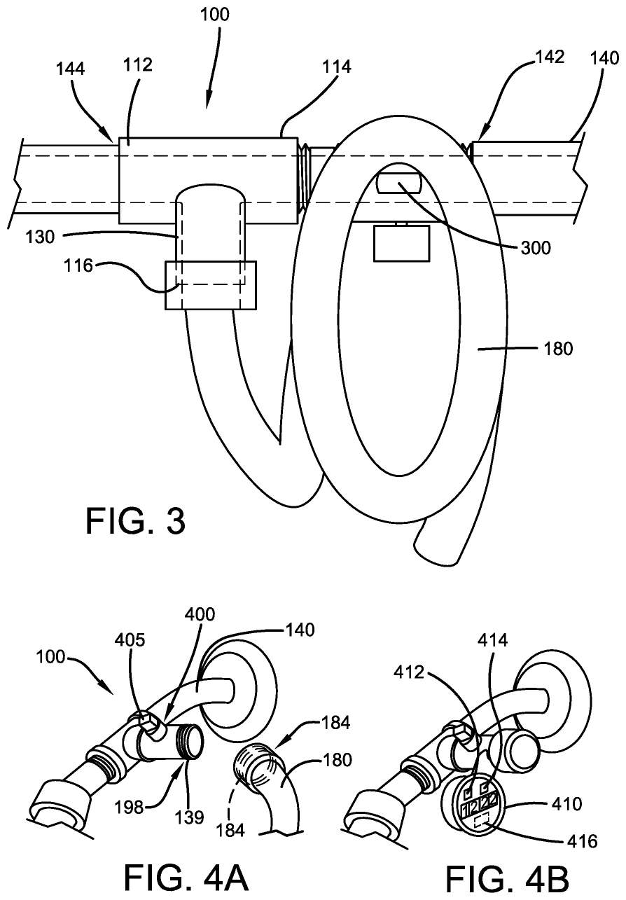

Referring initially to the drawings, FIG. 1 illustrates a perspective view of one potential embodiment of the plumbing diverter attachment 100 of the present invention in accordance with the disclosed architecture, wherein the device 100 is installed in line with a shower head supply line 140 (shown as prior art). More specifically, the plumbing accessory device 100 is comprised of a generally T-shaped body 110, a connector device 130, and a cap 150. The device 100 has a hollow interior to allow for the passage of water therethrough and is constructed from a material that is suitable for channeling and transporting water such as a durable metal (e.g., copper), or a plastic (e.g., PVC). In one embodiment of the attachment 100, the body 110 may be in the form of a brass one-half inch street tee, the cap 150 may be in the form of a three-fourth inch brass cap, and the connector 130 may be in the form of a one-half inch×three-fourth inch brass water hose fitting. In addition, the device 100 may be comprised of a one-half inch water diverter 122 and a one-half inch×one inch brass short nipple 120, wherein the diverter 122 attaches to a water source supply line 140 and the nipple 120 is attached to the diverter and the body 110 (as seen in FIG. 3).

The device 100 is further comprised of a first leg 112, a second leg 114, and a third leg 116, wherein each of the first and second legs 112, 114 is further comprised of a continuous opening 113,115 therein having the same longitudinal axis. The third leg 116 also comprises a continuous opening 117 therein that is in fluid communication with the continuous openings 115 of the first and second legs 112, 114, but is (and has a longitudinal axis that is) generally perpendicular to the longitudinal axis of the first and second legs 112, 114. More specifically, when installed on an existing water source such as a showerhead supply line 140 as shown in FIG. 1, the first and second legs 112, 114 are in line and in fluid communication with the water source supply line 140, and the third leg 116 is roughly perpendicular thereto, thereby having the ability to divert water away from the supply line 140.

Any supply line 140 is typically further comprised of an inlet side 142 and an outlet side 144, wherein the flow of water travels from the inlet side 142 toward the outlet side 144. As best shown in FIG. 1, the first leg 112 of the device 100 is attached to and in fluid communication with the inlet side 142 of the supply line 140, and the second leg 114 of the device 100 is attached to and in fluid communication with the outlet side 144 of the supply line 140. The attachment points of the device 100 to the supply line 140 must be both secure and watertight as the water within the supply line 140 is generally pressurized. The attachment points may be threaded, soldered, compression fit, Sharkbite, PEX or any other suitable connecting mechanisms known in the art.

Accordingly, each of the first leg 112 and the second leg 114 are generally cylindrical in shape and correspond in size (i.e., diameter) to the inlet and outlet sides 142,144 of the supply line 140. Further, the third leg 116 is also generally cylindrical in shape and corresponds in size (i.e., diameter) to the first leg 112 and the second leg 114. In the preferred embodiment, the entire device 100 is preferably integrally formed so as to minimize the number of different connection points and the potential for a water leakage. Notwithstanding, it is also contemplated that the first, second and third legs 112, 114, 116 could all be individually formed and subsequently attached to one another by any attachment means commonly known in art such as, without limitation, a threaded connection, soldering, compression fit, Sharkbite, PEX, etc.

The third leg 116 is further comprised of an outboard end 118 that refers to the portion of the third leg 116 positioned furthest away from the first and second legs 112, 114. The outboard end 118 is preferably threaded to connect to the connector 130, as explained more fully below. Alternatively, the outboard end 118 of the third leg 116 may also be connected directly to a water hose 180 when, for example, the device 100 is being used to divert a stream of water to a water hose 180, or the outboard end 118 of the third leg 116 may be connected directly to the cap 150 when, for example, it is not necessary to direct the stream of water to the water hose 180 and instead, for example, to the shower head 170, as best shown in FIG. 1. It is also contemplated that the outboard end 118 will not be threaded, but rather attached to any of the connector 130, the cap 150 or the water hose 180 by another suitable means such as, but not limited to, soldering, compression fit, Sharkbite, PEX, etc., provided that the connection is both secure and watertight.

The connector 130 is comprised of an inlet 132, an outlet 134, and a continuous opening 136 therein that extends from the inlet 132 to the outlet 134 and wherein the longitudinal axis of the continuous opening 136 is substantially aligned with the longitudinal axis of the continuous opening 117 of the third leg 116. Like the body 110, the connector 130 is also preferably comprised of a material that is suitable for channeling and transporting water such as a durable metal (e.g., copper), or a plastic (e.g., PVC).

The cap 150 has an end portion 152, a side wall 154 and a connection point 156. The cap 150 can be any shape or size that is able to be securely attached to the outward end 118 of the third leg or the outlet 134 of the connector 130 in a watertight manner. The cap 150 is preferably constructed from a solid material, but may also be comprised of pliable materials such as, but not limited to, a rubber or silicone which may effectively establish a watertight seal between the cap 150 and either of the outward end 118 of the third leg or the outlet 134 of the connector 130.

As stated above and best shown in FIG. 1, the first leg 112 of the diverter device 100 is connected to, and in fluid communication with the inlet 142 of the water supply line 140, and the second leg 114 of the diverter device 100 is connected to and in fluid communication with the outlet 144 of the water supply line 140. In one particular embodiment, the inlet 142 is inserted into the continuous opening 115 of the first leg 112 and the outlet 144 is inserted into the continuous opening 115 of the second leg 114 so that a watertight seal is automatically formed and water is prevented from leaking from either of the connection points. This sealing method allows for a quick and easy inline installation of the device 100 in the water supply line 160. However, it should be understood that the mechanism to fasten the device 100 to the water supply line 140 is not so limited, and other connection means such as those listed above are also contemplated.

Additionally, in a preferred embodiment of the present invention, each of the first, second and third legs 112, 114, 116 are substantially the same length and size. Nonetheless, the present invention is not so limited and each of the first, second and third legs 112, 114, 116 may be of different lengths and/or sizes. For example, the third leg 116 may be longer in length to make it more accessible to the user 190 for purposes of attaching a select one of the connector 130, cap 150 or water hose 180. In any event, the length and/or size of each of the first, second and third legs 112, 114, 116 may be any size required to suit user need and/or preference.

The outward end 118 of the third leg 116 and/or the outlet 134 of the connector 130 may further comprise a threaded hose attachment 138 that contains male threads 139 suitable for attaching the female connector 182 of the water hose 180, wherein the female connector contains female threads 184 (as seen in FIG. 4A). When not needed, the threaded attachment 138 is preferably covered by the cap 150, whose interior surface may contain female threads (not shown). The size of the water hose 180 suitable for use with the present invention includes ⅜″, ½″ ⅝″, and diameter hoses that preferably have a female threads 184 having 11.5 threads per inch. In one particular embodiment, the female fitting 182 of the hose 180 is screwed onto the threaded male portion of either the outward end 118 of the third leg 116 or the outlet 134 of the connector 130 until the connection is hand tight and can no longer be turned. However, the device 100 of the present invention is not so limited, and any other mechanism for attaching a water hose 180 to the diverter device 100 or connector 130 may be used. For example, the connector 130 may be a device that is compatible with a water hose 180 in such a way that threading the water hose 180 is not needed, and instead the water hose 180 can simply push onto the connector 130 (or the outward end 118 of the third leg), thereby clicking into place by using male and female connectors (not shown).

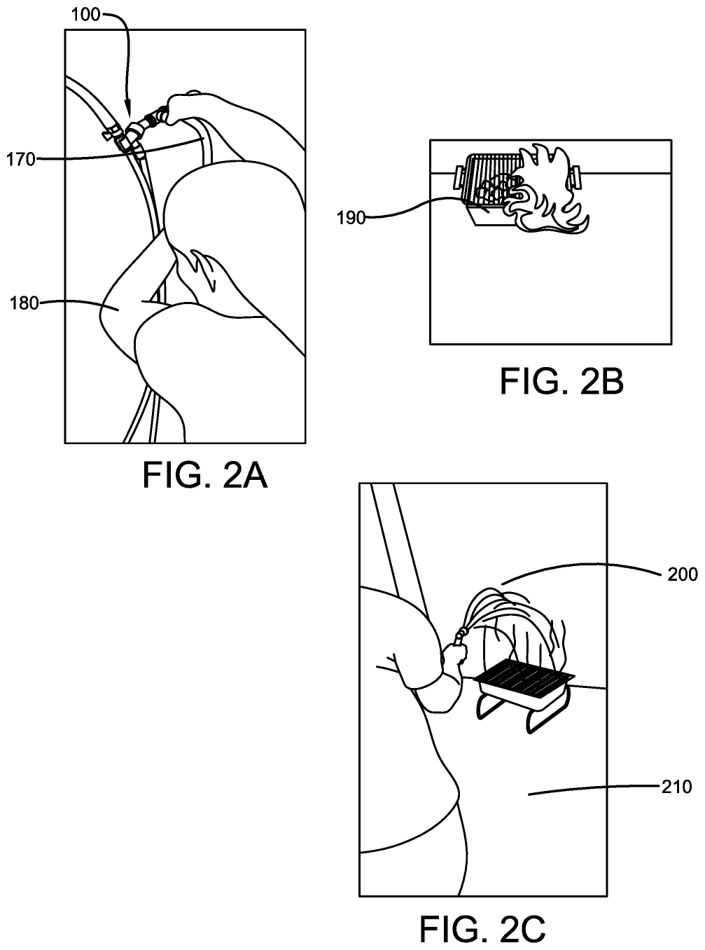

FIG. 2A illustrates a perspective view of a user 190 attaching a water hose 180 to one potential embodiment of the plumbing accessory device 100 of the present invention in accordance with the disclosed architecture, wherein the device 100 has already been installed inline on a supply line 140 between the inlet 142 and the outlet 144. More specifically, the user 190 may either attach the water hose 180 directly to the outward end 118 of the third leg 116, or to the outlet 134 of the connector 130. In either event, the device 100 is within easy reach of the user 190, as little effort is required to quickly attach the water hose 180 to the device 100, wherein a user 190 simply reaches above the shower head 170, in close proximity to where the supply line 140 enters the wall and attaches the water hose 180.

FIG. 2B illustrates a perspective view of a cooking grill 195 on a patio 196 that has caught on fire 198 and threatens the home of the user 190 and the people and possessions therein, and FIG. 2C illustrates a perspective view of the user 190 quickly extinguishing the cooking grill fire 198 of FIG. 2B with the water hose 180, which is attached to one potential embodiment of the plumbing accessory device 100 of the present invention in accordance with FIG. 2A. More specifically, to extinguish the fire 198 the user 190 simply removes the cap 150 (with the water supply turned off) and attaches the water hose 180 directly to the outward end 118 of the third leg 116, or to the outlet 134 of the connector 130 as described above. Once attached, the user 190 simply turns on the water supply which progresses through the supply line 140 past the inlet 142 and into the device 100, wherein a portion of the pressurized water supply is diverted through the third leg 116, the connector 130 (if applicable) and into the water hose 180. Further, the user 190 may then extend the water hose 180, for example, to the patio 196 to put out the fire 198. The water hose 180, which is now in fluid communication with the supply line 140 may also be used for other tasks that require water, for example, watering plants, cleaning, etc. When the water hose 180 is no longer needed, it can be easily disconnected from the third leg 116 of the diverter device 100 or the connector 130 as appropriate, and the cap 150 may then be installed on either the third leg of the diverter device 100 or the connector 130 as appropriate and in the manner described above.

FIG. 3 illustrates a side perspective view of one potential embodiment of the plumbing accessory device 100 of the present invention in accordance with the disclosed architecture, wherein the device 100 further comprises a support element 300 for holding the water hose 180 when not in use. More specifically, the device 100 may comprise a support element 300, in the form of a hook or other structure, that protrudes outwardly from the exterior surface of the diverter device 100 and is capable of supporting a water hose 180 that may already be in fluid communication with the supply line 140. Therefore, when an emergency arises such as a fire, the user 190 does not have to spend valuable time removing the cap 150 and attaching the water hose 180 to the third leg 116 of the diverter device 100 or the connector 130 as appropriate, and may simply turn on the water supply to address the emergency. Further, when not supporting a water hose 180, the support element 300 may be used for other purposes such as supporting a shower brush, cleaning brush or other items one may find in or near a shower or sink area.

FIG. 4A illustrates a perspective view of an alternative embodiment of the plumbing accessory device 100 of the present invention in accordance with the disclosed architecture, wherein the device 100 is installed in line with a water supply line 140 and comprises a water regulator valve 400. The water regulator valve 400 is repositionable between an open position and a closed position via a handle 405 that can be turned to achieve each position. In the open position, the flow of water from the inlet portion 142 of the supply line 140 is only permitted to pass through the first leg 112 and the third leg 116 of the diverter device 100 so that an ample supply of water and water pressure is available to be used via the hose 180 to, for example, extinguish the fire 198. Stated differently, when in the open position, the flow of water from the inlet portion 142 of the supply line 140 is not permitted to pass through the second leg 114, the supply line outlet 164 or the showerhead 170.

When the water regulator valve 400 is in the closed position, the flow of water from the inlet portion 142 of the supply line 140 is only permitted to pass through the first and second legs 112, 114 of the device 100 so that an ample supply of water and water pressure is available to be used for a shower head 170 or other attached device. Stated differently, when in the closed position, the flow of water from the inlet portion 142 of the supply line 140 is not permitted to pass through the third leg 116, the connector 130 (if connected to the third leg 116) or the water hose 180. The presence of the water regulator valve 400 allows the user 190 to eliminate the need for the cap 150 and to keep the water hose 180 attached to the plumbing accessory 180 at all times in case of emergency. As stated above, the water hose 180 may be conveniently supported by support element 300 when not in use. Further, the water regulator valve 400 may further be comprised of a handle 405 for repositioning the water regulator valve 400 between the open and closed positions and vice versa.

FIG. 4B illustrates a perspective view of an alternative embodiment of the plumbing accessory device of the present invention in accordance with the disclosed architecture, wherein the device is installed in line with a water supply line and further comprises a water metering device 410. The water metering device 410 may be provided to show flow rates or water usage of the shower and/or may include a timer 412 with an alarm that plays via a speaker 414 which can indicate when the user 190 has been in the shower long enough (e.g., when a selected amount of water has flowed through the meter). In this way, users in geographic areas that are on water restrictions can limit their use of water, and monitor their consumption. Each of the timer and the alarm may further be powered by a battery 416 within the device 410.

As used herein, the term “water source” refers to any pipe or system whereby water flows and is transported from one location to another. Also, as used herein, the term “water hose” refers to any type of long plastic, composite or other rubber tube used to transport a liquid, such as water, from one location to another. In addition, as used herein, the term “patio” 198 refers to any type of open outdoor area or platform that extends from, or is in close proximity to, a house. Although the preferred use of the device 100 is to provide quick access to a water source to extinguish a fire, the device 100 is not so limited and may also be used for any other purpose that may satisfy the needs and/or preferences of the user, including watering house plants, bathing pets and people, washing and cleaning of floors and other areas within the house.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “plumbing diverter attachment”, “plumbing diverter attachment device”, “attachment” and “device”, are interchangeable and refer to the plumbing diverter attachment 100 of the present invention.

Notwithstanding the forgoing, the plumbing accessory 100 of the present invention and its various components can be of any suitable size and configuration as is known in the art without affecting the overall concept of the invention, provided that they accomplish the above stated objectives. One of ordinary skill in the art will appreciate that the size, configuration, and material of the plumbing accessory 100 and its various components as shown in the FIGS. are for illustrative purposes only, and that other configurations of the plumbing accessory 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plumbing fixture comprising:
a diverter device comprised of a first leg, a second leg, and a third leg, wherein a first continuous opening having a first longitudinal axis extends through each of the first and second legs, and further wherein the third leg comprises a second continuous opening therein having a second longitudinal axis; and
a cap.

2. The plumbing fixture as recited in claim 1, wherein the second longitudinal axis is perpendicular to the first longitudinal axis.

3. The plumbing fixture as recited in claim 1, wherein the first continuous opening is in fluid communication with the second continuous opening.

4. The plumbing fixture as recited in claim 1, wherein the cap is removably attached to the third leg.

5. The plumbing fixture as recited in claim 1 further comprising a connector having a continuous opening therein.

6. The plumbing fixture as recited in claim 5, wherein the connector is attached to the third leg of the diverter device.

7. The plumbing fixture as recited in claim 6, wherein the connector is in fluid communication with each of the first, second and third legs.

8. The plumbing fixture as recited in claim 6, wherein the connector is in fluid communication with each of the first and third legs, but is not in fluid communication with the second leg.

9. The plumbing fixture as recited in claim 6, wherein the cap is removably attached to the connector.

10. The plumbing fixture as recited in claim 1 further comprising a water regulating device, wherein the water regulation device is repositionable between an open position and a closed position via a handle.

11. The plumbing fixture as recited in claim 10, wherein when the water regulation device is in the open position, a supply of water is permitted to flow through each of the first and third legs, but not the second leg.

12. The plumbing fixture as recited in claim 10, wherein when the water regulation device is in the closed position, a supply of water is permitted to flow through each of the first, second and third legs.

13. A quick connect water accessory comprising:
a street tee;
a water hose fitting;
a cap;
a nipple; and
a water diverter.

14. The quick connect water accessory as recited in claim 13, wherein each of the street tee, the cap and the water hose fitting are comprised of brass.

15. The quick connect water accessory as recited in claim 14, wherein the water hose fitting is attached to a first leg of the street tee and the cap is removably attached to the water hose fitting.

16. The quick connect water accessory as recited in claim 15, wherein the nipple is attached to a second leg of the street tee in series.

17. The quick connect water accessory as recited in claim 16, wherein the water diverter is attached to the nipple in series on an opposite end of the nipple as the second leg of the street tee.

18. A water supply system comprising:
a water supply line beginning at a water source and terminating at a water spout;
a diverter device attached to, and in fluid communication with, the water supply line between the water source and the water spout, wherein the diverter device is comprised of a first leg having a first continuous opening, a second leg having a second continuous opening, and a third leg having a third continuous opening, and further wherein the third continuous opening is perpendicular to each of the first and second continuous openings;
a connector having an inlet, an outlet and a continuous opening extending between the inlet and the outlet, wherein the inlet of the connector is attached the third leg;
a water hose removably attached to the outlet; and
a water regulation device.

19. The water supply system as recited in claim 18 further comprising a water meter.

20. The water supply system as recited in claim 18, wherein the water regulation device is repositionable between an open position and a closed position, and further wherein when the water regulation device is in the open position, a supply of water is permitted to flow through the water hose.
